(19) United States
(12) Patent Application Publication
(10) Pub. No.: US 2003/0068113 A1
(43) Pub. Date: Apr. 10, 2003

(54) Method for polarization birefringence compensation in a waveguide demultiplexer using a compensator with a high refractive index capping layer.

(76) Inventors: Siegfried Janz, Ottawa (CA); Dan-Xia Xu, Gloucester (CA); Pavel Cheben, Ottawa (CA); Andre Delage, Gloucester (CA); Lynden Erickson, Cumberland (CA); Boris Lamontagne, Ottawa (CA); Sylvain Charbonneau, Cumberland (CA)

Correspondence Address: MARKS & CLERK, P.O. BOX 957, STATION B, OTTAWA, ON, K1P 5S7, CA

(21) Appl. No.: 10/054,911

(22) Filed: Jan. 25, 2002

Related U.S. Application Data
(63) Continuation-in-part of application No. 09/986,318, filed on Nov. 8, 2001.

(30) Foreign Application Priority Data
Sep. 12, 2001 (CA) 2,357,235

(51) Int. Cl. G02B 6/27; G02B 6/12; G02B 6/26

(52) U.S. Cl. 385/11; 385/14; 385/27

(57) ABSTRACT

A method is disclosed for polarization birefringence compensation in a photonic device with a slab waveguide having a core. A compensator region is formed in the slab waveguide to minimize the wavelength shift between light of different polarizations. A thin capping layer, typically of silicon nitride, having a higher refractive index than the core, is formed on the compensator region to increase the birefringence contrast between the compensator region and the planar waveguide.

### CROSS REFERENCE TO RELATED APPLICATIONS

This application is a continuation-in-part under 35 USC §120 of U.S. patent application Ser. No. 09/986,318 filed on Nov. 8, 2001.

### BACKGROUND OF THE INVENTION

1. Field of the Invention

This invention relates to the field of photonics, and in particular to a method of polarization birefringence compensation in planar waveguide devices or waveguide based multiplexing or demultiplexing devices. The compensator can remove the polarization dependent wavelength shift in planar waveguide echelle grating, arrayed waveguide grating (AWG) or any other planar devices.

2. Description of Related Art

Wavelength multiplexers and demultiplexers are the key components in a wavelength division multiplexed (WDM) communication system that combine and separate the wavelength channels. All planar waveguide based demultiplexers in use today suffer from polarization sensitivity because of the refractive index birefringence of the waveguide material (usually glass). Any given multiplexer/demultiplexer wavelength channel output will undergo a wavelength shift Δλ as the input polarization is changed. Since optical telecommunications fiber is not polarization maintaining, a polarization induced wavelength shift is unacceptable in components intended for WDM system applications. In glass waveguides, this birefringence is usually dominated by strain birefringence arising from the mismatch in thermal expansion coefficients in the substrate and waveguide materials.

There are several techniques in use for eliminating the polarization dependent wavelength shift. In one technique the upper waveguide cladding is made up of a material with thermal expansion coefficient matched to the substrate. For the case of a ridge waveguide, the top cladding can balance the thermally induced in-plane (i.e. parallel to the substrate) strain with a vertical strain. In this way the total strain induced effective index birefringence of a ridge waveguide can be eliminated. The cladding material can be a Boron doped glass. A. Kilian, J. Kirchhof, B. Kuhlow, G. Przyrembel, W. Wischmann, J. Lightwave Technol. 18, 193 (2000). This technique can only be used for AWG demultiplexers, since the cladding layer must surround a ridge waveguide on three sides to be effective. It cannot balance the strain in a slab waveguide section in an echelle grating based demultiplexer.

Alternatively a half-wave plate can be inserted in the demultiplexer to flip the polarization of the guided light. If the optical path lengths before and after the wave plate are identical, the TE and TM light will undergo exactly the same total phase shift propagating through the two haves of the device, and the effect of birefringence is eliminated. H. Takahashi, Y. Hibino, I. Nishi, Optics Letters 17, 499 (1992). This technique cannot be used for echelle grating based devices. It also introduces additional insertion loss. Insertion of the wave plate into the planar waveguide device is a difficult device assembly challenge.

Prism shaped etched compensator sections can be placed in the combiner/splitter sections of a planar waveguide demultiplexer, or in the waveguide array section of an AWG device. These prism shaped sections refract the TE and TM light by different amounts in such a way that the TE-TM wavelength shift is zero. J. J. He, E. S. Koteles, B. Lamontagne, L. Erickson, A. Delage, M. Davies, Photonics. Technol. Lett. 11, 224 (1999). This technique involves changing the waveguide dimensions in the device. As result, there will be additional optical loss at the junction between the etched and unetched compensator sections. If the loss is too high, this solution may not be acceptable.

A thin (10 nm) silicon nitride layer can be deposited adjacent to the waveguide core layer. This layer creates a strong polarization dependent waveguide birefringence (of purely geometrical origin, rather than material origin), which can be designed to exactly balance the strain induced birefringence. K. Worhoff, P. V. Lambeck, A. Driessen, J. Lightwave Technol. 17, 1401 (1999). This solution requires the growth of a 10 nm (approximate) silicon nitride layer with a typical thickness tolerance of approximately 1 nm. This is difficult to achieve over a full wafer with standard deposition tools

### SUMMARY OF THE INVENTION

Accordingly the present invention provides a method of polarization birefringence compensation in a photonic device with a slab waveguide having a core, comprising forming in said slab waveguide a compensator region to minimize the wavelength shift between different polarizations; and providing a capping layer having a higher refractive index than said core on said compensator region to increase the birefringence contrast between said compensator region and said planar waveguide.

The capping layer is preferably silicon nitride, silicon oxynitride, or titanium oxide. The slab waveguide is typically glass. It typically has a thickness in the range 60 to 130 nm.

The compensator region can be inserted in the slab waveguide section of an echelle grating demultiplexer or arrayed waveguide grating (AWG). The strength of the compensator varies directly with the difference in birefringence ΔB between the compensator waveguide and the non-etched slab waveguide section. In the conventional compensator, ΔB can be increased only by etching deeper, which results in higher mode mismatch losses at the slab/compensator junction. In the case of typical glass AWG and echelle grating devices, the etch depth required to fully compensate the strain birefringence can lead to unacceptable mode mismatch losses and other fabrication problems.

The invention depends on the realization that the strength of a compensator can be increased by depositing a thin high index layer on top of the compensator section of the demultiplexer. SiNₓ (n˜1.9) or TiOₓ (n˜2.3) can be used for this purpose. Other suitable materials include silicon oxynitride. Calculations show that a SiN layer of the correct thickness can more than double the effectiveness of a compensator in eliminating TE-TM wavelength shift. The SiN layer can also still be effective if a second thin low index layer, such as SiO₂, is added on top of the SiN layer. The purpose of the SiO₂ layer is to reduce the sensitivity of the compensator to variations in the deposited layer thicknesses, although such a layer can also increase the effectiveness of the compensator. Other suitable low refractive index materials could also be used for this purpose.

A SiN thickness much larger than 130 nm should not be used since it will cause a strong distortion of the waveguide mode. This limits the maximum birefringence correction that may be achieved by using a SiN layer alone. The birefringence correction can be made somewhat stronger by adding the second low index SiO₂ layer. The thicknesses of the nitride and SiO₂ cannot be too large; otherwise significant distortion of the waveguide mode shape may result.

The high index SiN nitride layer can be effective even when added on a compensator that has a 0.5 or 1 μm top cladding, as in the original demultiplexer designs.

The SiN thickness required to reduce Δλ, defined as the shift in channel wavelength for TE and TM light, to zero for an existing demultiplexer with a given compensator and etch depth can be calculated if Δλ and the layer structure are known.

The invention also provides a photonic device with polarization birefringence compensation, comprising a slab waveguide having a core; a birefringence compensator formed in said slab waveguide to minimize wavelength shift between different polarizations; and a capping layer on said compensator to increase the birefringence contrast between said compensator region and said planar waveguide, said capping layer having a refractive index higher than said core. The capping layer may or may not have an additional lower index layer on top for the purposes of adjusting the compensator birefringence.

### BRIEF DESCRIPTION OF THE DRAWINGS

The invention will now be described in more detail, by way of example, only with reference to the accompanying drawings, in which:

FIG. 1 is a plan view of an echelle grating demultiplexer die, showing the echelle grating and the etched compensator regions;

FIG. 2 is a plan view of an arrayed waveguide grating (AWG) demultiplexer showing input/output waveguides, phase array, and input/output slabs with compensating regions;

FIG. 3 is chart showing the variation of geometrical birefringence with thickness of a SiN cap on top of a compensator waveguide structure with no cladding between the core and the SiN layer;

FIG. 4 is a chart showing the variation of geometrical birefringence with thickness of SiN cap on top of the compensator waveguide structure, for 0, 0.5 and 1.0 μm cladding between the core and the SiN layer. Index of SiN is taken as n=2 for these calculations;

FIG. 5 shows a SiN compensation layer deposited only on the compensator to increase the compensator strength for eliminating the TE-TM wavelength shift of the demultiplexer; and

FIG. 6 shows the same structure as FIG. 5, but with a thin SiO₂ layer deposited on top of the SiN to adjust the compensator strength.

### DETAILED DESCRIPTION OF THE PREFERRED EMBODIMENTS

In J. J. He's paper on the integrated polarization compensator referred to above, the birefringence induced wavelength shift is given by:

$$Δλ = λ \cdot [ \frac{Δ N - ( Δ {N}_{comp} - Δ N ) γ}{N - ( {N}_{comp} - N ) γ} ] \qquad ( 1 )$$

where

N: effective index of the three layer slab guide

N_{comp}: effective index of the etched compensator section

λ: geometrical compensator size parameter

ΔN, ΔN_{comp}: effective index birefringence (N_{TE}-N_{TM}) of the slab and compensator sections

Since N and N_{comp} are almost equal, this equation can be rewritten as

Δλ˜Δλ₀−γ·ΔB·(λ/N) (2)

where

Δλ₀=λ(ΔN/N): wavelength shift of the demultiplexer in absence of a compensator

ΔB=ΔN_{comp}−ΔN: difference in birefringence between slab and compensator sections

To a good approximation the effective index birefringence is a sum of the waveguide geometrical birefringence and the stress induced material birefringence.

ΔN=Δn_{geom.}+Δnₘₐₜ

It is observed from Eq. (1), that the compensation can be increased by increasing the size of the compensator (larger γ) or by increasing the birefringence contrast ΔB.

Since the material birefringence is the same for both compensator and slab, ΔB will depend mainly only on the difference in geometrical waveguide birefringence. The birefringence contrast can be increased by etching deeper, or by adding a thin high index layer (e.g. Silicon Nitride, n˜1.9) on top of the compensator. For any given demultiplexer with a fixed compensator size and remaining TE-TM wavelength shift Δλ, it is necessary to calculate how thick a SiN layer must be added to bring Δλ to zero. From equation 2, the required birefringence contrast is:

ΔB=Δλ(1/γ) (N/λ)+ΔB′ (3)

where ΔB′ is the birefringence contrast before adding the SiN layer, and Δλ is the measured wavelength shift before adding the SiN. Assuming ΔB depends only on the difference in geometrical birefringence between the slab and compensator sections, Equation 3 can be expressed in terms of the geometrical index birefringence of the compensator alone (since the slab birefringence is unchanged by SiN deposition.

Δn_{geom}=Δλ(1/γ) (N/λ)+Δn′_{geom}

The geometrical birefringence for any given compensator layer structure can be calculated for any waveguide using techniques well know to persons skilled in the art, so all quantities on the right side are known for a given device. Equation (4) then gives the required geometrical birefringence to fully compensate a device for TE-TM wavelength shift.

Once Δn_{geom} is determined, the required SiN overlayer thickness can be found from the graphs presented in the following pages for different layer structures we encounter in our recent devices.

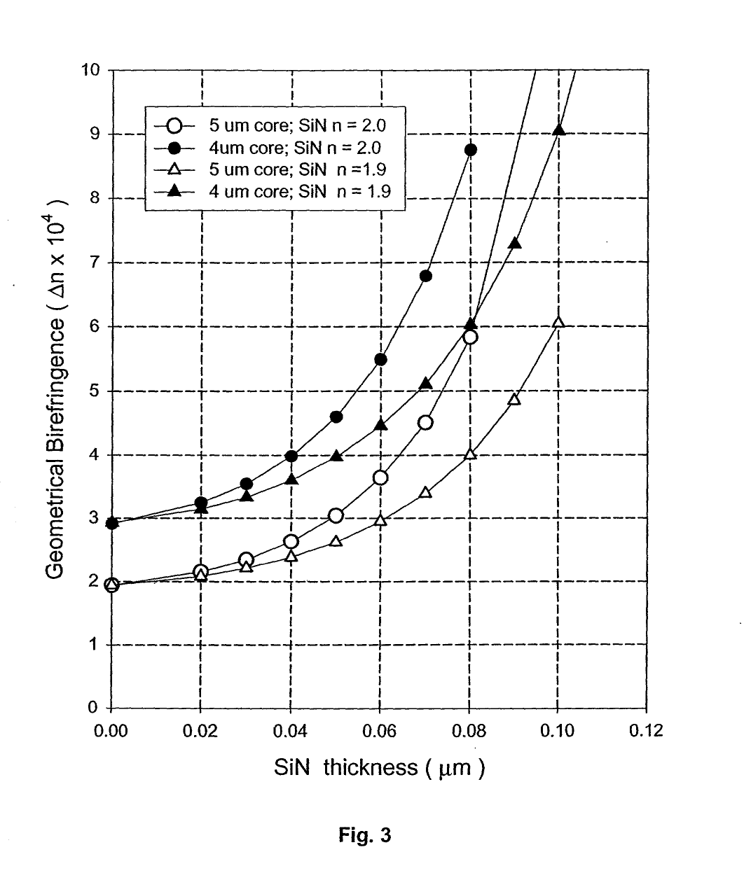

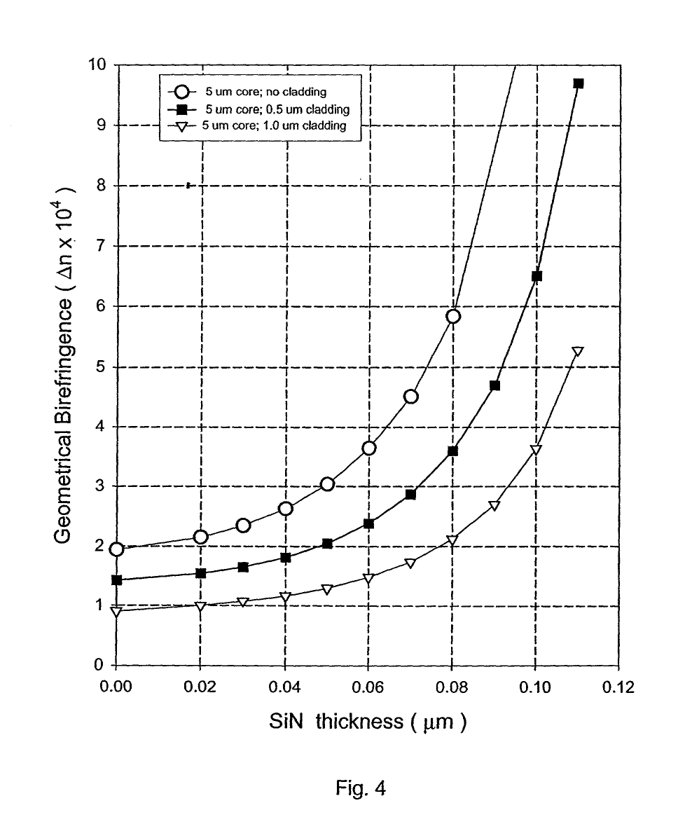

To evaluate the SiN thickness required to bring Δλ to zero (using Equation 4), it is necessary to know the variation of Δn_{geom} with SiN thickness on the compensator. This has been calculated using a mode solver for a number of different cases and is plotted in FIGS. 3 and 4. Calculations were carried out assuming a buffer index of 1.45, and a core index of 1.462. There is some variation of SiN index. The SiN layers have index values ranging from 1.84 to 1.91, although they can be as high as 1.955. The index values used are indicated on the graphs captions. Calculations have been carried out for 5 μm and 4 μm cores (FIG. 3), for compensators with a thin cladding layer between the SiN and core layer (FIG. 4). The value of Δn′_{geom} required in Equation 4 is just the value of the geometrical birefringence for SiN thickness of zero in the graphs below. In the exemplary waveguides the material birefringence (stress) is Δnₘₐₜ˜−4×10⁻⁴ while the compensator geometrical birefringence (two layer structure, 0.012 index step, 5 μm core) is approximately Δn_{comp}˜+1.9×10⁻⁴. For the corresponding three layer slab section the geometrical birefringence is approximately Δn_{slab}=+0.31×10⁻⁴. As an example, doubling the compensator strength require an increase in the geometrical birefringence of the compensator section to about Δn=4×10^{-4.} As shown in FIGS. 3 and 4, this can be done by adding several hundred Angstroms of SiN or other high index layer, even when a cladding layer is present above the core.

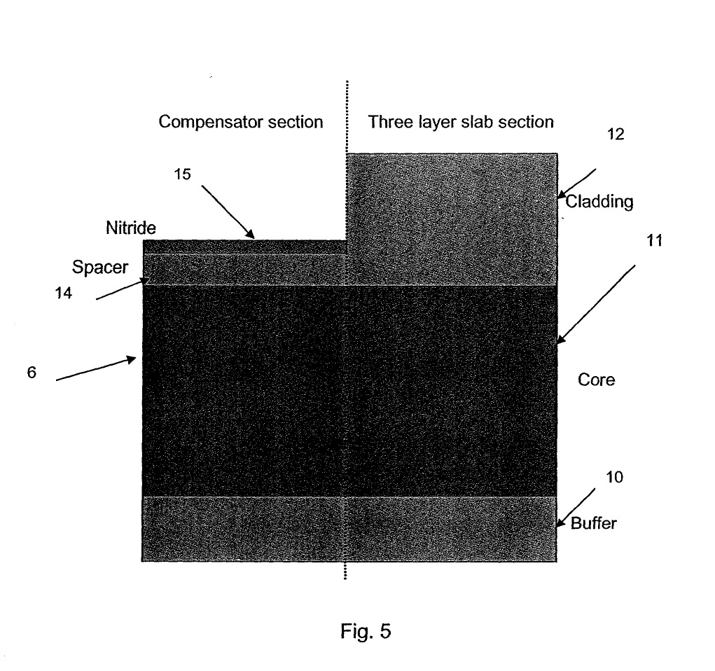

A waveguide mode solver can be used to calculate the required accuracy in SiN index and SiN layer to achieve a TE-TM wavelength shift less than ±0.05 nm in the demultiplexer with compensator size given by γ=1. A waveguide with a 5 μm core and a 0.012 index step are assumed. The material birefringence of the waveguide is approximately Δnₘₐₜ=−0.00046, a value typical for annealed glass layers on silicon. The SiN layer is deposited on the compensator section only, with or without a spacer layer of the cladding material, as shown in FIG. 5. Table 1 gives the tolerances calculated for different spacer layer thicknesses between the high index cap layer and the waveguide core. Tolerances on index and thickness for a SiN layer deposited on the compensator. The index of SiN is assumed to be 1.9. Calculations are done for a compensator strength γ=1.

For the cases considered here, average absolute tolerance on SiN thickness is approximately ±50 Å for the SiN on compensator, with an average SiN thickness of about 1100 Å required to achieve full compensation. The spacer layer does not have a large effect on the tolerances. Therefore the advantages of the spacer layer may depend on potential improvements in insertion loss, waveguide mode properties, and PDL.

TABLE 1

| | | | Thickness | Thickness |
|---|---|---|---|---|
| Spacer | Target SiN | Index | Tolerance | Tolerance |
| Thickness | Thickness | Tolerance | (absolute) | (relative) |
| 0 μm | 835 Å | ±0.035 | ±60 Å | ±7% |
| 0.5 μm | 1070 Å | ±0.02 | ±48 Å | ±4% |
| 1.0 μm | 1290 Å | ±0.013 | ±36 Å | ±3% |

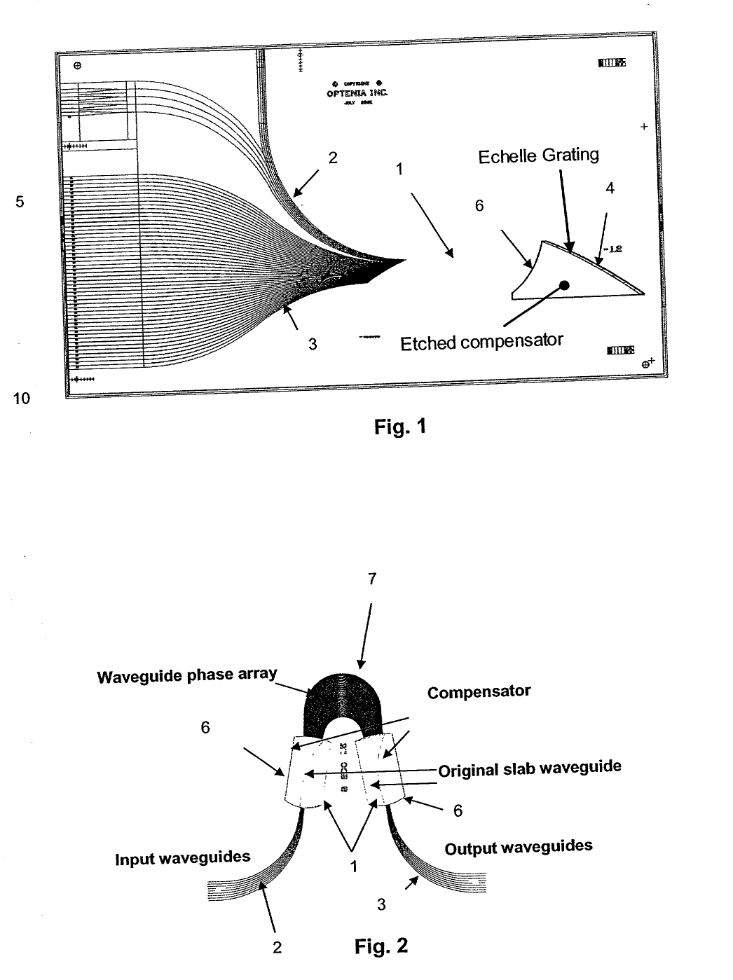

Referring now to FIG. 1, the exemplary echelle grating demultiplexer comprises a slab waveguide 1, typically made of glass, coupled to input and output waveguides 2, 3 and an echelle grating 4. Light from the input waveguides 2 is guided through the slab waveguide 1 and after being diffracted from the echelle grating 4 is directed to one of the output waveguides 3 depending on its wavelength.

The right side of FIG. 5 is a section through the slab waveguide 1. This comprises a buffer layer 10, a core 11, and a cladding 12.

A prism-shaped compensator 6 is etched into the slab waveguide in the manner generally described in J. J. He et al referred to above.

FIG. 2 shows a similar arrangement for a waveguide phase array. In this case the input and output waveguides a coupled to waveguide phase array 7 by slab waveguides 1 each having etched compensator regions 6.

The basic compensator region is etched as described in J. J. He et al., the contents of which are herein incorporated by reference. However, in accordance with the principles of the invention, the birefringence of this compensator region 6 is increased by covering the compensator with a thin capping layer 15, which has a higher refractive index than the core refractive index. In the case of planar waveguide devices this thin layer 15 is suitably silicon nitride. This layer 15 increases the difference in birefringence of the compensator 16 and slab sections 1 of the demultiplexer. The layer 15 is separated from the core layer by a residual-spacer overcladding layer 14 of cladding material. This layer typically has a thickness less than 130 nm.

The high index layer 15 can be selected to have a negligible effect on the waveguide mode shape, but a large enough effect on the waveguide birefringence that the effectiveness of the compensator can be increased by a factor of two or more over that for a conventional etched compensator.

This technique permits the use of a much shallower etch in forming the compensator, so that mode mismatch between the compensator and slab waveguide sections are negligible. It also allows the thin overcladding layer 14 to be left over the waveguide core in the compensator section. This overcladding layer reduces waveguide losses due to surface roughness and the presence of other materials (e.g. metal) on top of the waveguide. In certain cases where the intrinsic slab waveguide birefringence is small or the cladding is thin, the presence of the high index layer alone may be sufficient to compensate the device, and the compensator etch is not required.

This technique has been experimentally demonstrated to reproducibly yield echelle grating demultiplexers with less than 0.05 nm TE-TM wavelength shifts. Furthermore, the use of the silicon nitride layer on the compensator has been demonstrated to have no detrimental effect on device cross-talk or insertion loss.

The required SiN thickness to eliminate the TE-TM wavelength shift Δλ in existing demultiplexers was estimated using measured Δλ data. The required geometrical birefringence Δn_{g} was calculated according to the procedure outlined above, and the SiN thickness to obtain Δn_{g} was calculated using a waveguide mode solver assuming a SiN refractive index of n=1.9. The modified Δλ was measured after deposition and is given in Tables 1 and 2. In all cases, the TE-TM wavelength shift has been reduced to Δλ=0.05 nm or less. This demonstrates that the SiN capping technique can be used to reproducibly reduce or the TE-TM wavelength shift of a demultiplexer. Measurements on devices with a SiN cap show that the insertion loss and cross talk are unchanged by the process. Results for two wafers are shown in tables 2 and 3.

TABLE 2

| | | Δλ before SiN | SiN thickness | Δλ after SiN |
|---|---|---|---|---|
| | Compensator | deposition | estimated for | deposition |
| Die | strength | (nm) | n = 1.9 (Å) | (nm) |
| D16 | 0.8 | 0.26 | 880 | 0 |
| D11 | 0.8 | 0.255 | 870 | 0 |
| D18 | 0.8 | 0.26 | 880 | 0 |
| D10 | 0.8 | 0.255 | 870 | 0.03 |
| D41 | 0.8 | 0.255 | 870 | 0.05 |
| D32 | 0.8 | 0.26 | 880 | 0.01 |
| D17 | 1 | 0.23 | 810 | 0 |
| D1 | 1 | 0.24 | 825 | 0 |
| D40 | 1 | 0.245 | 795 | −0.02 |
| D19 | 1.2 | 0.22 | 750 | 0.05 |
| D33 | 1.2 | 0.215 | 740 | 0.02 |
| D42 | 1.2 | 0.225 | 755 | 0 |

TABLE 3

| | | Δλ before SiN | SiN thickness | Δλ after SiN |
|---|---|---|---|---|
| | Compensator | deposition | estimated for | deposition |
| Die | strength | (nm) | n = 1.9 (Å) | (nm) |
| D36 | 0.8 | 0.26 | 910 | 0 |
| D35 | 1 | 0.225 | 770 | 0.01 |
| D40 | 1 | 0.225 | 770 | 0.01 |
| D42 | 1.2 | 0.225 | 755 | 0.01 |

In the embodiment of shown in FIG. 5, in order to meet the required polarization dispersion specifications, the nitride layer thicknesses should be accurate to within approximately ±100 nm. A similar tolerance applies to the nitride index of refraction.

In the embodiment shown in FIG. 6, a lower refractive index overlying layer 20 of SiO₂ (N≅1.46) is deposited on top of the silicon nitride layer (N≅1.9). The strength of the compensator is adjusting by varying the thickness of the SiO₂ layer 20. The change in Δλ with oxide thickness is now approximately three times smaller than for an identical change in the thickness of the nitride layer 15.

Table 4 gives the corresponding slope of Δλ with thickness, as well as the thickness tolerance required to meet the requirement that Δλ=0.01±0.01 nm.

TABLE 4

| | | Thickness | Target SiO2 |
|---|---|---|---|
| Nitride Thickness | Δλ/Δt (nm/Å) | tolerance (Å) | thickness (Å) |
| 1090 | 10.5 × 10⁻⁴ | ±9.5 | 0 |
| 1000 | 3.6 × 10⁻⁴ | ±27.5 | 205 |
| 900 | 3.3 × 10⁻⁴ | ±30 | 520 |
| 800 | 2.8 × 10⁻⁴ | ±36 | 920 |

Table 4 shows that the slope of Δλ/Δt (where t is the thickness) for the SiO₂ thicknesses given varies slowly with the underlying nitride thickness. Therefore, even if the SiN layer thickness is uncertain to within ±100 Å, the amount of SiO₂ that needs to be removed or added to make a fall within the acceptable range is almost the same.

It will be appreciated that the described compensators yield demultiplexers having a very low TE-TM shift without having a detrimental effect on device cross-talk or insertion loss.

It will be appreciated that any suitable material can be used for the capping layer provided it has a refractive index higher than the core index. Although the invention has been described and illustrated in detail, it is clearly understood that the same is by way of illustration and example only and is not to be taken by way of limitation, the spirit and scope of the present invention being limited only by the terms of the appended claims.

We claim:

1. A method of polarization birefringence compensation in a photonic device with a slab waveguide having a core, comprising:
forming in said slab waveguide a compensator region to minimize the wavelength shift between different polarizations; and
providing a capping layer having a higher refractive index than said core on said compensator region to increase the birefringence contrast between said compensator region and said planar waveguide.

2. A method as claimed as claimed in claim 1, wherein said compensator region is a region of reduced thickness in said slab waveguide.

3. A method as claimed in claim 2, wherein said region of reduced thickness is etched into said slab waveguide.

4. A method as claimed in claim 2, wherein said compensation region is in the form of a prism.

5. A method as claimed in claim 1, wherein said capping layer is silicon nitride.

6. A method as claimed in claim 1, wherein said capping layer is silicon oxynitride.

7. A method as claimed in claim 2, wherein said slab waveguide has a cladding layer over said core, an overcladding layer of cladding material is retained over said core in said compensator region, and said capping layer is formed on said overcladding layer.

8. A method as claimed in claim 1, wherein said slab waveguide is made of glass.

9. A method as claimed in claim 1, wherein the thickness of said capping layer is less than 130 nm.

10. A method as claimed in claim 9, wherein the thickness of said capping layer ties in the range from about 60 nm to about 130 nm.

11. A method as claimed in claim 1, further comprising forming an additional lower refractive index layer to overly said capping layer to reduce the sensitivity of the compensator to variations in deposited layer thicknesses.

12. A method as claimed in claim 11, wherein said additional lower refractive index layer is SiO₂.

13. A method as claimed in claim 11, wherein the thickness of said lower refractive index layer is adjusted to polarization dispersion within target specifications.

14. A photonic device with polarization birefringence compensation, comprising:
a slab waveguide having a core;
a birefringence compensator formed in said slab waveguide to minimize wavelength shift between different polarizations; and
a capping layer on said compensator to increase the birefringence contrast between said compensator region and said planar waveguide, said capping layer having a refractive index higher than said core.

15. A photonic device as claimed in claim 14, wherein said compensator is a region of reduced thickness in said slab waveguide.

16. A photonic device as claimed in claim 15, wherein said region of reduced thickness is etched in said slab waveguide

17. A photonic device as claimed in claim 15, wherein said compensator is in the form of a prism.

18. A photonic device as claimed in claim 14, wherein said capping layer is silicon nitride.

19. A photonic device as claimed in claim 14, wherein said capping layer is silicon oxynitride.

20. A photonic device as claimed in claim 15, wherein said slab waveguide has a cladding layer over said core, an overcladding layer of cladding material is retained over said core in said compensator region, and said capping layer is formed on said overcladding layer.

21. A photonic device as claimed in claim 15, wherein said slab waveguide is made of glass.

22. A photonic device as claimed in claim 14, wherein the thickness of said capping layer is less than 130 nm.

23. A photonic device as claimed in claim 14, wherein the thickness of said capping layer lies in the range from about 60 nm to about 130 nm.

24. A photonic device as claimed in claim 14, wherein said photonic device is an arrayed waveguide grating demultiplexer.

25. A photonic device as claimed in claim 14, wherein said photonic device is an echelle grating demultiplexer.

26. A photonic device as claimed in claim 14, further comprising a an additional lower refractive index layer overlying said capping layer to reduce the sensitivity of the compensator to variations in the thicknesses of the deposited layers.

27. A photonic device as claimed in claim 26, wherein said additional lower refractive index layer is SiO₂.

28. A photonic device with polarization birefringence compensation, comprising:
a slab waveguide having a core;
a region of reduced thickness in said slab waveguide forming a birefringence compensator to minimize wavelength shift between different polarizations; and
a capping layer on said compensator to increase the birefringence contrast between said compensator region and said planar waveguide, said capping layer having a refractive index higher than said core and being selected from the group consisting of silicon nitride and silicon oxynitride.

29. A photonic device as claimed in claim 28, wherein said region of reduced thickness is etched in said slab waveguide.

30. A photonic device as claimed in claim 28, wherein said capping layer is less than 130 nm thick.

31. A photonic device as claimed in claim 28, further comprising an overcladding layer between said core and said capping layer in said compensator region.

32. A photonic device as claimed in claim 28, wherein the thickness of said capping layer lies in the range from about 60 nm to about 130 nm.

33. A photonic device as claimed in claim 28, further comprising a an additional lower refractive index layer overlying said capping layer to reduce the sensitivity of the compensator to variations in the thicknesses of the deposited layers.

34. A photonic device as claimed in claim 33, wherein said additional lower refractive index layer is SiO₂.
